(19) United States
(12) Patent Application Publication
(10) Pub. No.: US 2026/0026506 A1
(43) Pub. Date: Jan. 29, 2026

(54) COMPOSITION FOR DISSOLVING AN OILY COMPOUND IN WATER

(71) Applicant: AFFIX LABS OY, Helsinki (FI)

(72) Inventors: Kaspar KOCH, Helsinki (FI); Stan Coenrard Marie FRANSSEN, Helsinki (FI)

(73) Assignee: AFFIX LABS OY, Helsinki (FI)

(21) Appl. No.: 18/998,084

(22) PCT Filed: Jul. 26, 2023
(86) PCT No.: PCT/EP2023/070773

§ 371 Date: Jan. 23, 2025

(30) Foreign Application Priority Data
Jul. 26, 2022 (NL) 2032600

(51) Int. Cl. A01N 47/16; A01N 25/02; A01N 25/30; A01P 7/04

(52) U.S. Cl. CPC A01N 47/16; A01N 25/02; A01N 25/30; A01P 7/04

(57) ABSTRACT

A composition for dissolving a water-insoluble active compound comprising: an alcohol, a surfactant, being a quaternary ammonium salt according to Formula I, and water, wherein R3 of Formula I is a C1-18 alkyl or alkene. The use of the composition comprising an active ingredient. The use of the composition with the active ingredient as an insect repellent insecticide, antimicrobial composition, antibacterial composition, fragrance or fungicide. Additionally, a method for repelling insects and a method of for dissolving a water-insoluble active compound. The use of such a composition for storing an active compound in extreme conditions.

The present invention relates to a composition for dissolving a water-insoluble active compound. The invention further relates to the composition comprising an active ingredient. The invention further relates to the use of the composition with the active ingredient as an insect repellent.

Insect repellents can prevent and control the outbreak of insect-borne, and other arthropod-borne, diseases such as malaria, Lyme disease, dengue fever, bubonic plague, river blindness, and West Nile fever. Most insect repellents are insecticides (bug killers), but some additionally discourage insects and send them flying or crawling away. Common insect repellents are DEET (N,N-diethyl-m-toluamide), permethrin and icaridin, also known as picaridin or saltidin. Icaridin is effective against the greatest range of insects, this chemical is a synthetic version of piperine, a repellent found in pepper plants. Icaridin also has minimal odor, no damaging effect on plastics and other synthetics and meets all requirements for human and environmental safety and effective use. Together with DEET, icaridin is therefore one of the most popular insect repellents.

Icaridin is often sold under its product name, Picaridin. This product is icaridin dissolved in a neat oil. A neat oil is a water-undiluted mineral or vegetable oil blended with certain additives in order to generate certain beneficial properties. Picaridin can further be diluted in organic solvents such as ethanol, dimethylsulfoxide (DMSO), and dimethyl formamide (DMF).

Due to its hydrophobic properties, it is impossible to dissolve an effective amount of icaridin in water. It is therefore impossible to prepare an aqueous solution comprising icaridin, which can be used as an insect repellent. Icaridin can therefore not be used in for example sprayable non-dangerous and non-harmful insect repellents such as active wall sprays, clothing sprays and topical skin formulations. The lack of a safe sprayable formulation comprising icaridin severely hampers the effectiveness of the compound. Furthermore, on a surface, the compound evaporates quicker thus limiting the time of action. Currently available icaridin products are based on alcohol, which makes the product flammable. This leads to logistical restrains and more implementation issues.

An alternative way of dissolving compounds having hydrophobic characteristics in water is dissolving these compounds by using cosolvents. Cosolvent techniques are however only deployed to solubilize solids or hydrophobic compound but not for compounds which are water-insoluble, such as oily compounds. Also, as another alternative, surfactants are often applied to dissolve oily compounds, however, adding surfactants only provides solubility to oily compounds in (very) low concentrations.

It is therefore an object of the invention to provide a composition for dissolving hydrophobic compounds in water.

It was surprisingly found that a composition comprising an alcohol, which is liquid at room temperature, and a surfactant, being a quaternary ammonium salt can be used to dissolve water-insoluble active compounds in water.

The alcohol is this composition is a cosolvent. Cosolvents are added to compositions to increase the solubility of a poorly soluble compound. Cosolvents are utilized in dissolving solubilize solids or hydrophobic compounds in aqueous systems but not in oily solvents.

The term surfactant is derived from the term surface-active agent. This means that the compound can lower the surface tension of a liquid or the interfacial tension between two liquids, between a gas and a liquid or between a solid and a liquid. Surfactants can therefor act as detergents, wetting agents, emulsifiers, foaming agents, or dispersants. In the context of this of the present invention, the surfactant acts as an emulsifier, which means that the surfactant will form a micelle or micelle like structure around the water-insoluble active compound.

The invention therefore relates to a use of a composition for dissolving a water-insoluble active compound, comprising:
an alcohol selected from the group consisting of: methanol, ethanol, propanol, propanol derivatives, butanol, and butanol derivatives,
a surfactant, being a quaternary ammonium salt according to Formula I, and
water,

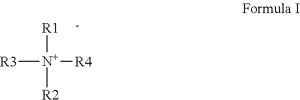

wherein R3 is a C1-18 alkyl or alkene.

The composition comprising the combination of a surfactant and a cosolvent thus enables to dissolve a water-insoluble compound in water.

The surfactant of the composition of the present invention is a quaternary ammonium salt according to Formula I. The surfactant forms a corona like structure with its hydrophobic side turned towards the water-insoluble compound and its hydrophilic sides turned towards the water molecules. Such surfactants allow the oily substance to form a stable mixture with the aqueous solution.

The invention provides a system which enables dissolving water-insoluble active compounds. The invention therefore further relates to the use of above composition, wherein the composition further comprises an effective amount of water-insoluble active compound, preferably an oily active compound.

The active compound of the composition of the present invention can be a naturally or synthetic insect repellent, insecticide, antimicrobial compound, antibacterial compound or fungicide, an aniline-based molecule, such as a dye, aroma, or odorant.

According to the invention, the active compounds can be selected from the group consisting of icaridin, DEET (N,N-diethyl-meta-toluamide), citronellal, citronellol, eucalyptol, nepetalactone, azadirachtin, A-terpineol, carvacrol, thymol, cinnamaldehyde, rosemary oil, cedarwood oil, myrcene, citral, geranyl acetate, nerol, geraniol, limonene, permethrin, zinc-pyrithione, or derivatives thereof, preferably, icaridin and derivatives thereof.

The surfactant of the composition of the invention can be split in four embodiments based on the definition of the R-groups. The first embodiment further defines R4.

The invention therefore further relates to the use of the above composition, wherein R4 of Formula I is a methyl group, an alkyl shorter than the alkyls in R1, R2 and R3 or wherein R4 of Formula I is one to three carbons with a carboxylic acid, hydroxy, sulfonate, quaternary silane group or phenyl group.

The second embodiment is directed to the use of the composition of the invention, wherein R1, R2 and R3 are the same.

Further, in the third embodiment, all R-groups are further defined. The invention therefore also relates to the use of the above composition, wherein R1, R2 are a methyl group, R3 is CₙH₂ₙ₊₁ with n=1-18 and R4 is an alkyl shorter than the alkyls in R1, R2 and R3, or R4 is one to three carbons and a carboxylic acid, hydroxy, sulfonate or phenyl group.

Finally, in the fourth embodiment, the invention relates to the use of the above composition, wherein each of R1, R2, R3 and R4 are the same.

The invention therefore also relates to the use of the above composition wherein the counter ion of the quaternary ammonium salt is a halide anion, preferably a chloride ion or a bromide ion.

The surfactants of the composition of the invention can be a compound selected from the list consisting of trimethyloctadecylammonium chloride, stearyltrimethylammonium chloride, hexadecyltrimethylammonium chloride, cetyltrimethylammonium chloride, tetradecyltrimethylammonium bromide, myristyltrimethylammonium bromide, tetradecyltrimethylammonium chloride, dodecyltrimethylammonium bromide, dodecyltrimethylammonium chloride, trimethylactylammonium chloride, tetramethylammonium chloride, dimethyloctadecyl [3-(trimethoxysilyl)propyl] ammonium chloride, cetyl dimethyl betaine, benzalkalkonium chloride, 3-(dimethyl(octadecyl)ammonio) propane-1-sulfonate, N-dodecyl-N,N-(dimethylammonio) butyrate (DDMAB), bezyldimethyldodecylammonium chloride, zephirol, N-dodecyl-N,N-dimethyl-3-ammonio-1-propanesulfonate, domiohen bromide, (lauryldimethylammonio) acetate, didecyldimethylammonium bromide, didodecyldimethylammonium bromide, methyltrioctylammonium chloride, tridodecylmethylammonium chloride, tetraoctylammonium bromide, tetradodecylammonium bromide, preferably trimethyloctadecylammonium chloride.

Alcohols are organic compounds with at least one hydroxy group. In the context of the present invention, the alcohol acts as a cosolvent. The alcohol as present in the composition of the present invention can be divided into four main categories that work in the cosolvent principle. The first category are the linear alcohols, these are hydrocarbons with one hydroxy group. The linear alcohols have variation in carbon chain length, however these linear alcohols do not possess branches. The second category are the branched alcohols, these are hydrocarbon chains with at least one branch, which has the length of at least a methyl group. The third category is depicted as Formula II. Each compound of this category of Formula II comprises a 1-butanol backbone, with two methyl groups and an R-group at the 3-position.

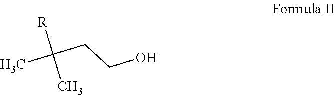

The final category involves the same alcohols as in the first three categories, however these alcohols contain at least two hydroxy groups instead of one.

The invention also relates to the use of the above composition, wherein the alcohol is liquid at room temperature, and wherein the alcohol is methanol, ethanol, propanol, propanol derivatives, butanol, or butanol derivatives.

In a further embodiment, the propanol derivative of the composition of the invention is 2-propanol or isopropyl ether-ethyl alcohol.

In another embodiment, the butanol derivative of the composition of the invention is selected from the list consisting of tert-butanol, isobutanol, 2-methoxy-3-methyl-1-butanol (MMB), 3-ethoxy-3-methyl-1-butanol, 3-benzyloxy-3-methyl-1-butanol, 3-methyl-3-methyl-1-butanol, 3-methyl-1,3-butanediol, and is preferably 2-methoxy-3-methyl-1-butanol (MMB).

According to the invention, the active compound is present in the composition in about 0.1 wt. % to about 44.9 wt. %, preferably about 0.1 wt. % to about 20 wt. %, more preferably in about 0.1 wt. % to about 10 wt. %, even more preferably in about 0.5 wt. % to about 7 wt. %, most preferably in about 1 wt. % to about 5 wt. %, most preferably in about 2 wt. % to about 3 wt. % with respect to the total weight of the composition.

The surfactant can be present in the composition of the invention in about 0.1 wt. % to 6 wt. %, preferably in about 0.5 wt. % to 4 wt. %, more preferably in about 0.75 wt. % to 3 wt. %, most preferably in about 1 wt. % to 2 wt. % with respect to the total weight of the composition.

The alcohol can be present in the composition in about 5 wt. % to 49.9 wt. %, preferably in about 7 wt. % to 40 wt. %, more preferably in about 9 wt. % to 30 wt. %, more preferably in about 10 wt. % to 25 wt. %, even more preferably in about 12 wt. % to 16 wt. %, most preferably in about 12.5 wt. % with respect to the total weight of the composition, with the proviso that water is present in the composition in a higher wt. % than any other component of the composition separately.

In the context of the present invention a solution is defined as a solute being dissolved in the solvent and resulting in a homogeneous mixture that is stable over time and will remain a homogenous stable mixture when passed through a filter.

Also, in the context of this invention the solvent in an aqueous solution is always liquid water. Therefore, a composition having multiple components is considered an aqueous solution when water is present in the composition in a higher wt. % than any other component of the composition separately.

Therefore, in another embodiment, the invention relates to the composition of the invention, wherein the water is present in the composition in a higher wt. % than any other component of the composition separately.

Also, in an embodiment of the invention, the water is deionized water.

In a further embodiment of the invention, the water is present in the composition in a higher wt. % than the other components of the composition together.

According to a preferred embodiment of the invention the water is present in the composition in more than 50 wt. %, preferably more than 60 wt. %, more preferably in more than 70 wt. %, most preferably in more than 80 wt. % with respect to the total weight of the composition or wherein the water is present in about 80 wt. % with respect to the total weight of the composition.

In a preferred embodiment, the invention relates to the above composition, wherein the composition comprises 2-methoxy-3-methyl-1-butanol, trimethyloctadecylammonium chloride, icaridin and water.

In this more preferred embodiment, the composition of the invention may comprise at least 12.5 wt. % methoxy-3-methyl-1-butanol and at least 1 wt. % trimethyloctadecylammonium chloride with respect to the total weight of the composition.

The composition of the invention can comprise an active compound, however the invention also relates to the use of the composition in which the active compound is not present, i.e. wherein the composition solely consists of the system for dissolving oily compounds. This latter composition comprises the alcohol in a different wt. % than the composition which does comprise the active compound. Therefore, the composition of the invention in which the active compound is not present can comprise alcohol in at least 12.5 wt. %, preferably between 12.5 wt. % and 50 wt. %, more preferably between 15 wt. % and 40 wt. %, even more preferably between 15 wt. % and 25 wt. %, most preferably in about 20 wt. % with respect to the total weight of the composition.

In the embodiment in which the composition of the invention does not comprise the active compound, the composition can also comprise the surfactant in a different wt. % than the composition which does not comprise the active compound. The composition of the invention in which the active compound is not present can comprise the surfactant in about 0.1 wt. % to 12 wt. %, preferably in about 0.5 wt. % to 8 wt. %, more preferably in about 0.75 wt. % to 4 wt. %, most preferably in about 1 wt. % to 2 wt. % with respect to the total weight of the composition.

The composition of the invention comprising the active compound is stable in extreme conditions such as overnight in a freezer, fridge or at 50° C. The invention therefore also relates to using the above composition for storing an active compound in such extreme conditions. The invention further relates to the use of the invention as described herein for storing the active compounds as described herein at a temperature between −20° C. and 20° C., in particular between −20° C. and 4° C., more in particular between −20° C. and 0° C. The invention also relates to the use of the invention as described herein for storing an active compound at a temperature between 20° C. and 60° C., in particular between 30° C. and 55° C., more in particular between 40° C. and 50° C.

The invention further relates to the use of the invention for storing an active compound at a temperature between −20° C. and 0° C. and/or 30° C. and 55° C.

Additionally, the composition of the invention comprising the active compound remains homogenous, translucent and colorless after storing the 3.5 months. The invention therefore also relates to the use of the above composition of the invention for storing the active compound for at least 1 week, in particular at least 1 month, more in particular at least 2 months, most in particular at least 3.5 months.

Further, the composition of the invention with the active compound can be used as an insect repellent, insecticide, antimicrobial composition, antibacterial composition fragrance, or fungicide. In particular, the composition of the invention can be used to repel insects, in particular in particular insects that have the potential to carry communicable diseases, more in particular mosquitoes, ticks, cockroaches, bed bugs, ants, biting flies, fleas and chiggers.

In another embodiment, the invention relates to the use of the above composition on a building, part of a building, building material such as concrete, plastic, brick, foam, or polyester. Implementing the composition of the invention into homes or building materials of homes enables a convenient application of the active compound present in the composition of the invention. When active compounds are in an aqueous solution, such compound are better implementable in homes or building materials of homes.

In a further embodiment, the invention relates to the use of the above composition in a coating, paint, epoxy, wood, brick, fibers, composite materials, or textile.

Also, in another embodiment, the composition of the invention can be used on human or animal skin. The composition of the application is an aqueous solution and is therefore not flammable and less hazardous. Consequently, application of the composition of the invention on the human or animal skin is more convenient and safer.

In addition, a further embodiment of the invention is that the composition can be used as topical skin composition, in particular a cosmetic lotion, spray, or cream or as part of topical skin composition, such as a lotion, spray or cream.

The invention further relates to a method for repelling insects, comprising:
applying the composition of the invention on a surface, wherein the surface is preferably human or animal skin, a surface of a building, or part of a building, building material or a coating.

The invention also relates to a method of manufacturing the composition of the invention without the active compound, comprising:
dissolving the alcohol and surfactant as described above in water to obtain a solution.

The invention also relates to a method for dissolving a water-insoluble active compound in water, comprising:
dissolving the alcohol and surfactant as described above in water to obtain a solution.
adding the in water in soluble active compound as described above to the solution.

The invention also relates to the use of the composition of the invention as an insect repellent, insecticide, antimicrobial composition, antibacterial composition, or fungicide.

The invention will now be illustrated by means of the following examples, which do not limit the scope of the invention in any way.

### FIGURE DESCRIPTION

FIG. 1: MMB and Trimethyloctadecylammonium chloride

FIG. 2: MMB and Dimethyloctadecyl [3-trimethoxysilyl) propyl] ammonium chloride

FIG. 3: MMB and Tetradecyltrimethylammonium chloride

FIG. 4: MMB and 3-(dimethyl(octadecyl)ammonio)propane-1-sulfonate

FIG. 5: MMB and Domiohen bromide

FIG. 6: MMB and Didodecyldimethylammonium bromide

FIG. 7: IPA and Trimethyloctadecylammonium chloride

FIG. 8: Methanol and Trimethyloctadecylammonium chloride

FIG. 9: Ethanol and Trimethyloctadecylammonium chloride

FIG. 10: Icaridin in water

FIG. 11: Icaridin in a mixture of water and MMB (45%)

FIG. 12: Icaridin in a mixture of water and MMB (25%)

FIG. 13: Icaridin in a mixture of water and MMB (12.5%)

FIG. 14: Icaridin with a surfactant in water

FIG. 15: MMB and Tetradodecylammonium bromide

FIG. 16: Icaridin switched for DEET

FIG. 17: Mosquito method (modular test system)

FIG. 18: Mosquito method (modular test system)

FIG. 19: Tetradecyltrimethylammonium chloride+MMB+Saltidin

FIG. 20: 3-(dimethyl(octadecyl)ammonio)propane-1-sulfonate+MMB+Saltidin

FIG. 21: Domiphen bromide+MMB+Salditin

FIG. 22: Didodecyldimethylammonium bromide+MMB+Saltidin

FIG. 23: SiQ (DTSACI)+MMB+Saltidin

FIG. 24: Isopropanol+IPA+Saltidin

FIG. 25: Methanol+IPA+Saltidin

FIG. 26: Ethanol+IPA+Saltidin

FIG. 27: Trimethyloctadecylammonium chloride+MMB+Dimethyl Phthalate

FIG. 28: Trimethyloctadecylammonium chloride+MMB+1,8-Cineole

FIG. 29: Trimethyloctadecylammonium chloride+MMB+Geraniol

FIG. 30: Trimethyloctadecylammonium chloride+MMB+Eugenol

FIG. 31: Trimethyloctadecylammonium chloride+MMB+2,5-Dimethyl-2,5-Hexanediol

FIG. 32: Trimethyloctadecylammonium chloride+MMB+Lemongrass Oil

FIG. 33: TEM-check: MMB+Domiphen bromide+Saltidin.

FIG. 34: TEM-check: MMB+Saltidin

### EXAMPLES

### Example 1

A general procedure to prepare the solution of an active compound in the composition of the invention is applied:
Deionized water was brought in a beaker equipped with a stirring bar and placed on a stirring plate. The cosolvent was added to the solution whilst stirring. Subsequently, the surfactant was added, and before the surfactant was dissolved also icaridin was added. Stirring is stopped when all components of the composition are dissolved.

The experiments are summarized in Table 1 below. The first column lists the cosolvent and surfactant that were used. The second column describes the results, and the third column provides the weight percentages of the various components.

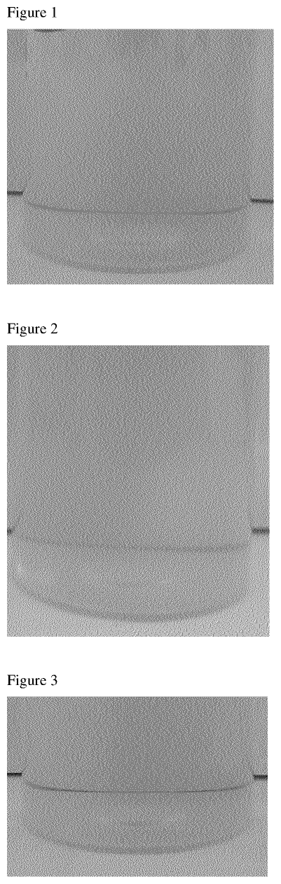

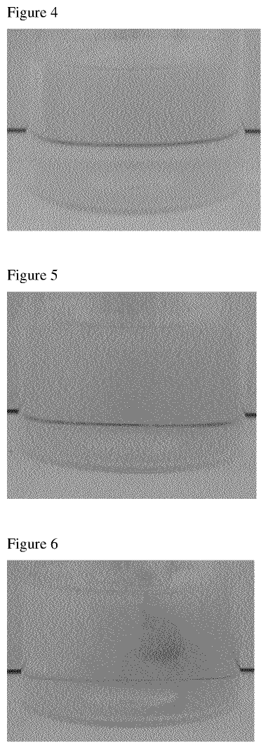

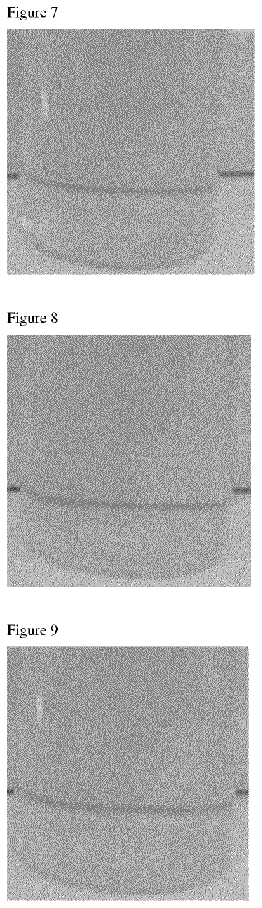

TABLE 1

| Description experiment | Result | Compounds (Wt. %) |
|---|---|---|
| MMB and | All compounds were mixed | Deionized water: 81.5 |
| Trimethyloctadecyl | together which yielded a | MMB: 12.5 |
| ammonium chloride | colourless translucent solution. | Trimethyloctadecyl |
| | It can thus be concluded that the | ammonium chloride: 1.0 |
| | combination of the used | |
| | surfactant and MMB leads to an | |
| | aqueous Icaridin solution. | Icaridin: 5.0 |
| | (Figure 1) | |
| MMB and | All compounds were mixed | Deionized water: 80.5 |
| Dimethyloctadecyl | together which yielded a | MMB: 12.5 |
| [3-trimethoxysilyl)propyl] | colourless translucent solution. | Dimethyloctadecyl |
| ammonium chloride | It can thus be concluded that the | [3-trimethoxysilyl)propyl] |
| | combination of the used | |
| | surfactant and MMB leads | ammonium chloride: 2.0 |
| | to an aqueous Icaridin | |
| | solution. (Figure 2) | Icaridin: 5.0 |
| MMB and | All compounds were mixed | Deionized water: 79.0 |
| Tetradecyltrimethyl | together which yielded a | MMB: 15.0 |
| ammonium chloride | colourless translucent solution. | Tetradecyltrimethyl |
| | It can thus be concluded that the | ammonium chloride: 1.0 |
| | combination of the used | Icaridin: 5.0 |
| | surfactant and MMB leads to an | |
| | aqueous Icaridin solution. | |
| | (Figure 3) | |
| MMB and 3- | All compounds were mixed | Deionized water: 79.0 |
| (dimethyl(octadecyl) | together which yielded a | MMB: 15.0 |
| ammonio)propane-1- | colourless translucent solution. | 3-(dimethyl(octadecyl) |
| sulfonate | It can thus be concluded that the | ammonio)propane-1- |
| | combination of the used | sulfonate: 1.0 |
| | surfactant and MMB leads to an | Icaridin: 5.0 |
| | aqueous Icaridin solution. | |
| | (Figure 4) | |
| MMB and Domiohen | All compounds were mixed | Deionized water: 79.0 |
| bromide | together which yielded a | MMB: 15.0 |
| | colourless translucent solution. | Domiohen bromide: 1.0 |
| | It can thus be concluded that the | Icaridin: 5.0 |
| | combination of the used | |
| | surfactant and MMB leads to an | |
| | aqueous Icaridin solution. | |
| | (Figure 5) | |
| MMB and | All compounds were mixed | Deionized water: 79.0 |
| Didodecyldimethyl | together which yielded a | MMB: 15.0 |
| ammonium bromide | colourless translucent solution. | Didodecyldimethyl |
| | It can thus be concluded that the | ammonium bromide: 1.0 |
| | combination of the used | Icaridin: 5.0 |
| | surfactant and MMB leads to an | |
| | aqueous Icaridin solution. | |
| | (Figure 6) | |
| IPA and | All compounds were mixed | Deionized water: 79 |
| Trimethyloctadecyl | together which yielded a | IPA: 15 |
| ammonium chloride | colourless translucent solution. | Trimethyloctadecylammonium |
| | It can thus be concluded that the | chloride: 1.0 |
| | combination of the used | Icaridin: 5.0 |
| | surfactant and MMB leads to an | |
| | aqueous Icaridin solution. | |
| | (Figure 7) | |
| Methanol and | All compounds were mixed | Deionized water: 79 |
| Trimethyloctadecyl | together which yielded a | IPA: 15 |
| ammonium chloride | colourless translucent solution. | Trimethyloctadecylammonium |
| | It can thus be concluded that the | |
| | combination of the used | chloride: 1.0 |
| | surfactant and MMB leads to an | |
| | aqueous Icaridin solution. | Icaridin: 5.0 |
| | (Figure 8) | |
| Ethanol and | All compounds were mixed | Deionized water: 79 |
| Trimethyloctadecyl | together which yielded a | IPA: 15 |
| ammonium chloride | colourless translucent solution. | Trimethyloctadecylammonium |
| | It can thus be concluded that the | chloride: 1.0 |
| | combination of the used | Icaridin: 5.0 |
| | surfactant and MMB leads to an | |
| | aqueous Icaridin solution. | |
| | (Figure 9) | |

### Example 2

In this experiment, it is tested if the combination of the cosolvent and the surfactant is required to dissolve icaridin or if individual components can also dissolve icaridin in water.

Deionized water was brought in a beaker equipped with a stirring bar and placed on a stirring plate. The (when applicable) cosolvent was added to the solution whilst stirring. Subsequently (when applicable) the surfactant was added, before this dissolved also (when applicable) icaridin was added. Stirring is stopped when everything is dissolved.

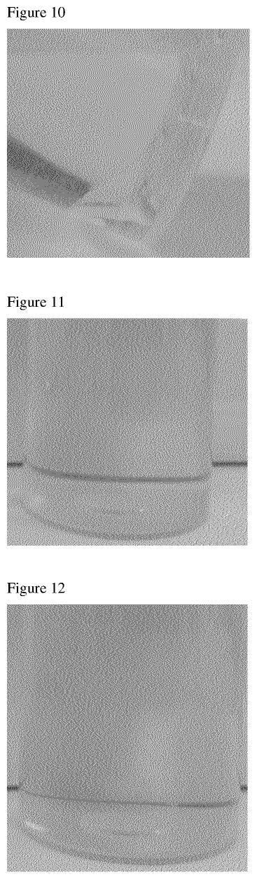

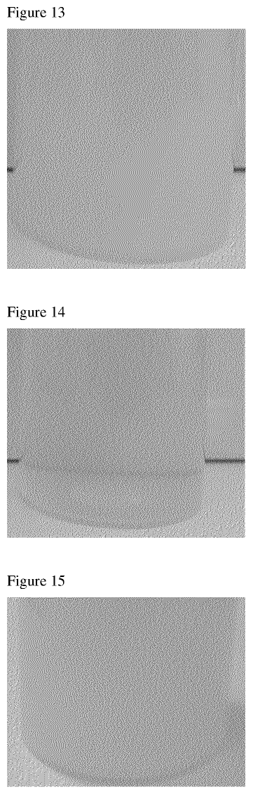

TABLE 2

| Description experiment | Result | Compounds (Wt. %) |
|---|---|---|
| Icaridin in water | Deionized water and icaridin | Deionized water: 95.0 |
| | were mixture together. Upon | Icaridin: 5.0 |
| | initial mixing this resulted in | |
| | a milky white solution that | |
| | was only 'Stable' for a few | |
| | hours. After wards face | |
| | separation occurred. This can | |
| | be seen in the picture. Icaridin | |
| | and water are present as | |
| | layers above each other. | |
| | Icaridin can thus not be | |
| | dissolved in water in our | |
| | desired concentration. | |
| | (FIG. 10) | |
| Icaridin in a mixture | All compounds were mixed | Deionized water: 50 |
| of water and MMB | together which yielded a | MMB: 45 |
| | colorless translucent solution. | Icaridin: 5.0 |
| | It can thus be concluded that a | |
| | relative high concentration of | |
| | MMB leads to an aqueous | |
| | Icaridin solution. (FIG. 11) | |
| Icaridin in a mixture | All compounds were mixed | Deionized water: 70 |
| of water and MMB | together which yielded a | MMB: 25 |
| | colorless translucent solution. | Icaridin: 5.0 |
| | It can thus be concluded that a | |
| | relative high concentration of | |
| | MMB leads to an aqueous | |
| | Icaridin solution. (FIG. 12) | |
| Icaridin in a mixture | All compounds were mixed | Deionized water: 82.5 |
| of water and MMB | together which yielded a | MMB: 12.5 |
| | milky white solution. | Icaridin: 5.0 |
| | It can thus be concluded that a | |
| | relative low concentration of | |
| | MMB without a surfactant | |
| | leads to an unstable solution | |
| | and thus not an aqueous | |
| | Icaridin solution. (FIG. 13) | |
| Icaridin with a | All compounds were mixed | Deionized water: 93.0 |
| surfactant in water | together which yielded a | Trimethyloctadecylammonium |
| | milky white solution with | chloride: 2.0 |
| | flakes in it. | Icaridin: 5.0 |
| | It can thus be concluded that | |
| | only a surfactant without | |
| | solvent leads to an unstable | |
| | solution and thus not an | |
| | aqueous Icaridin solution. | |
| | (FIG. 14) | |
| MMB and | All compounds were mixed | Deionized water: 79.0 |
| Tetradodecylammonium | together which yielded a | MMB: 15.0 |
| bromide | milky white solution with | Tetradodecylammonium |
| | flakes in it. | bromide: 1.0 |
| | It can thus be concluded that | Icaridin: 5.0 |
| | an unstable solution is present | |
| | and thus not an aqueous | |
| | Icaridin solution. Therefor | |
| | this surfactant is not useful. | |
| | (FIG. 15) | |

From Table 2 it can be concluded that icaridin is only soluble in water using the combination cosolvent and surfactants.

### Example 3

The same test was applied to determine if the composition of the invention is also able to dissolve alternative water-insoluble compounds. In this experiment icaridin was switched for DEET and the general procedure was applied.

TABLE 3

| Description experiment | Result | Compounds (Wt. %) |
|---|---|---|
| General procedure was | All compounds were mixed | Deionized water: 81.5 |
| followed. Icaridin was | together which yielded a clear | MMB: 12.5 |
| switched for DEET | translucent solution. | Trimethyloctadecylammonium |
| | It can thus be concluded that a | chloride: 1.0 |
| | stable solution is present and | DEET: 5.0 |
| | thus possible to obtain an | |
| | aqueous solution with other | |
| | non-water solvable | |
| | compounds. (FIG. 16) | |

In Table 3, it is demonstrated that the composition of the invention also enables dissolving DEET in 5 wt. % in water.

### Example 4

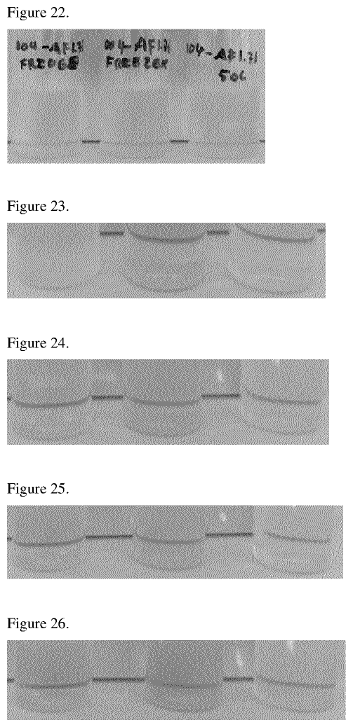

General procedure of testing multiple cosolvents and surfactants for dissolving Saltidin in extreme conditions: Deionized water (8.15 g, 81.50 wt %) was brought in a beaker equipped with a stirring bar and placed on a stirring plate. The cosolvent (1.25 g, 12.50 wt %) was added to the solution whilst stirring. Subsequently the surfactant (0.10 g, 1.00 wt %) was added, before this dissolved, Saltidin (0.5 g, 5.00 wt %) was also added. When everything is dissolved, stirring is stopped.

| Description experiment | Result |
|---|---|
| Tetradecyltrimethylammonium | Stable overnight and stable at 100 mL Scale with the general |
| chloride + MMB + | procedure and MMB. |
| Saltidin | As alternative 0.5 wt % of the surfactant together with 15 wt % |
| | MMB can be used. |
| | Fridge: upon removal stable, overnight also stable, |
| | Freezer: After thawing and swirling stable, overnight also |
| | stable, 50C: upon removal stable, overnight also stable. |
| | (FIG. 19) |
| 3-(dimethyl(octadecyl)ammonio) | Solution can be stabilized with 25 wt % MMB and 1 wt % |
| propane-1-sulfonate + | surfactant or with 12.5 wt % MMB and 2 wt % Surfactant. If |
| MMB + Saltidin | 15% MMB is present instead of 12.5% MMB then solution is |
| | stable. |
| | Fridge: upon removal stable, overnight also stable, |
| | Freezer: After thawing and swirling stable, overnight also |
| | stable ,50C: upon removal stable, overnight also stable |
| | (FIG. 20). |
| Domiphen bromide + MMB + | Solution can be stabilized with 25% MMB and 1% surfactant |
| Salditin | or with 12.5% MMB and 2% Surfactant. |
| | If 15% MMB is present instead of 12.5% MMB then solution |
| | is stable. |
| | Fridge: upon removal stable, overnight also stable, |
| | Freezer: After thawing and swirling stable, overnight also |
| | stable ,50C: upon removal stable, overnight also stable |
| | (FIG. 21). |
| Didodecyldimethylammonium | Solution can be stabilized with 25% MMB and 1% surfactant. |
| bromide + MMB + Saltidin | If 15% MMB is present instead of 12.5% MMB then solution |
| | is stable. |
| | Fridge: upon removal stable, overnight also stable, |
| | Freezer: After thawing and swirling stable, overnight also |
| | stable, 50C: upon removal stable, overnight also stable |
| | (FIG. 22). |
| SIQ (DTSACI) + MMB + | Initially stable, also stable overnight and stable at 100 mL |
| Saltidin | Scale with the general procedure and MMB Initially 2.0% SiQ |
| | is used). |
| | Fridge: upon removal stable, overnight stable, Freezer: |
| | After thawing and swirling Stable, overnight stable, 50C: |
| | upon removal cloudy, overnight still cloudy. From left to |
| | right 50 degrees, fridge, freezer (FIG. 23). |
| Isopropanol + IPA + | Initially stable, also stable overnight and stable at 100 mL |
| Saltidin | Scale with the general procedure and IPA at 15.0%. |
| | Fridge: upon removal stable, overnight stable, Freezer: |
| | After thawing and swirling stable, overnight stable ,50C: |
| | upon removal stable, overnight stable. From left to right |
| | 50 degrees, fridge, freezer (FIG. 24). |
| Methanol + IPA + | Initially stable, also stable overnight and stable at 100 mL |
| Saltidin | Scale with the general procedure and MeOH at 15.0%. |
| | Fridge: upon removal stable, overnight stable, Freezer: |
| | After thawing and swirling stable, overnight stable ,50C: |
| | upon removal stable, overnight stable. From left to right |
| | 50 degrees, fridge, freezer (FIG. 25). |
| Ethanol + IPA + | Initially stable, also stable overnight and stable at 100 mL |
| Saltidin | Scale with the general procedure and EtOH at 15.0%. |
| | Fridge: upon removal stable, overnight stable, Freezer: |
| | After thawing and swirling stable, overnight stable, 50C: |
| | upon removal stable, overnight stable. From left to right |
| | 50 degrees, fridge, freezer (FIG. 26). |

### Example 5. Dissolving Multiple Active Compounds with the System Comprising the Cosolvents and Surfactants

### General Procedure

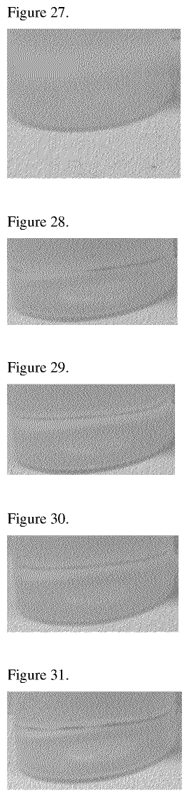

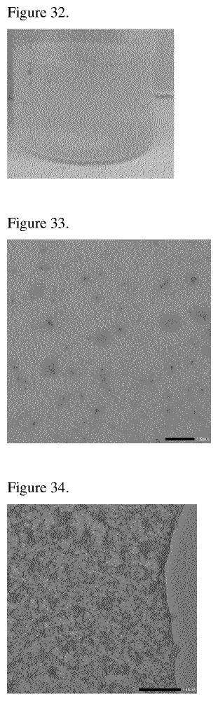

Deionized water (8.15 g, 81.50 wt %) was brought in a beaker equipped with a stirring bar and placed on a stirring plate. The cosolvent (1.25 g, 12.50 wt %) was added to the solution whilst stirring. Subsequently the surfactant (0.10 g, 1.00 wt %) was added, before this dissolved the active compound (0.5 g, 5.00 wt %) was also added. Stop stirring when everything is dissolved.

| Description experiment | Result |
|---|---|
| Trimethyloctadecylammonium chloride | Stable (FIG. 27) |
| + MMB + Dimethyl Phthalate | |
| Trimethyloctadecylammonium chloride | Stable (FIG. 28) |
| + MMB + 1,8-Cineole | |
| Trimethyloctadecylammonium chloride | Stable (FIG. 29) |
| + MMB + Geraniol | |
| Trimethyloctadecylammonium chloride | Stable (FIG. 30) |
| + MMB + Eugenol | |
| Trimethyloctadecylammonium chloride | Stable (FIG. 31) |
| + MMB + 2,5-Dimethyl-2,5- | |
| Hexanediol | |
| Trimethyloctadecylammonium chloride | Stable (FIG. 32) |
| + MMB + Lemongrass Oil | |

### Example 6. GC-Method and NMR-Method

The GC-method is performed to demonstrate that the active compound is present in the solution. The GC-method experiment is performed according to the following steps:
1. Prepare an internal standard solution (IS) via dilution of EBAP (Ethyl butylacetylaminopropionate, cas #52304-36-6) with IPA (2-propanol, cas #67-63-0) to obtain a 1% EBAP solution in IPA.
2. Prepare a rinse solution. Dilute the IS solution 100 times with IPA to 0.01% EBAP.
3. Cut pieces of Whatman no. 1 paper (25 mm×40 mm+10 mm (10 cm2+2.5 cm2)).
4. Cut pieces 100% cotton shirts (25 mm×40 mm+10 mm (10 cm2+2.5 cm2))
5. Prepare a to be tested solution as stated in section 3.1.
6. Apply to each of five papers and five textile pieces, 20 μL of the to be tested solution with a micro pipette in a spot like pattern of ˜2 μL per spot.
7. Before a sample is taken. Prepare 10 sample vials (25 mL) by filling them with 10 mL rinse solution each.
8. Transfer the papers/textile sheets to their corresponding sample vials and make sure they are full emerged in solution.
9. Once all the papers and textile pieces are in a sample vial, leave them for at least 8 h. Next transfer 1 mL of each solution into a GC vial and measure GC following the specifics in the table below.
10. Check if the compound peak is present at the expected retention time.

TABLE 4
Equipment and information of GC-chromatography.

| Equipment | Information | | |
|---|---|---|---|
| Gas Chromatography | Shimadzu 2010 | Injector | 250° C. |
| (GC) | | | |
| GC Software | GC solution version | Detector temperature | 325° C. |
| | 2.30.00 | | |
| Column | Thermo TG-5SILMS; | Make up flow | nitrogen/air 30 |
| | 30 m; | | mL/min |
| | ID 0.25 mm; film | | |
| | 0.25 um | | |
| Program | 0:00-2:00 (min:sec) | Hydrogen flow | 60 mL/min |
| | −150° C., | | |
| | 2:00-10:30 ramp to | | |
| | 320° C. (20° C. /min) | | |
| Ionization mode | EI | Air flow | 400 mL/min |
| Split | 10 | Sampling rate | 40 ms |
| Injection Volume | 1 μL | Retention time IS | 4.3-4.5 min |
| Carrier gas | 1 bar, 21 mL/min | Retention time | 5.0-5.1 min |
| | | Icaridin | |
| Column flow | 1.77 mL/min | GC vials + Caps | 1.5 mL, septa caps |
| | | Gilson pipette | 2-10 μL, 10-200 |
| | | | μL, |
| | | | 100 - 1000 μL |

An NMR-method is also performed to demonstrate that the active compound is present in the solution. The NMR-method experiment is performed according to the following steps:
Dissolve 25 μg of the solution in 0.7 mL of DMSO-d6 or CDC13 depending on the active compound and measure an NMR on a 500 MHz machine at least. Make sure to do a prediction of the active compound and other compound and identify the signals.

### Example 7. Trans Emission Electroscopy

| Composition: | Result: |
|---|---|
| TEM-check mixture: | Particle (Most likely micelles, judging from |
| Demineralized water: 79.0%, 7.9 g | their size) like structures are visible. Size |
| MMB: 15.0%, 1.5 g | 50-100 nm (FIG. 33). |
| Domiphen bromide: 1.0%, 0.1 g | |
| Saltidin: 5.0%, 0.5 g | |
| Demineralized water: 70.0%, 7.0 g | One big inhomogeneous structure is visible |
| MMB: 25.0%, 2.5 g | (FIG. 34). |
| Saltidin: 5.0%, 0.5 g | |

### Example 8. Mosquito Method

The following mosquito method is performed to prove that an active compound is still active in the formulation for insect repellent compounds.

In lack of official standard methodology, the procedure was based upon the “Guidelines for efficacy testing of spatial repellent” from the World Health Organization (Guidelines for efficacy testing of spatial repellent, World Health Organization, 2013, ISBN 978 92 4 150 502 4).

For the preparation of the test samples, aliquots of the IRLs (Insect Repellent Liquids) were applied (3.0 mL) evenly to a 20.0×27.5 cm (550 cm2) paper (type: Whatman No 1.) with a micro pipette. The samples were dried at ambient conditions (20-25° C.) without any forced heating. All IRLs were stored in their original packaging at 15-25° C. until the start of the test.

Female mosquitoes of the genera Anopheles Arabiensis KGB were reared according to a standard protocol. The mosquitoes were reared at a temperature of 27±2° C., a relative humidity of 80±10%, and a photoperiod of 11.5 h light: 45 min dusk: 11.15 h dark: 45 min dusk. Pupae were collected and transferred to a screen cage where they were enclosed as adults. Adults were maintained in screen cages with a 10% sucrose solution as an energy source. Five to eight-day old non-blood-fed female nulliparous mosquitoes were starved (provided only with water) for 24 h before testing. Actively host-seeking females were selected from general colony groups to ensure a maximum behavioural response. This was done with an aspirator or an appropriate airflow apparatus while holding a hand close to (but not touching) the cage and collecting those mosquitoes that actively probe. All repellency tests were observed in female mosquitoes starved for preceding 12 h. The mosquitoes were transferred to holding containers with care to avoid physically damaging them.

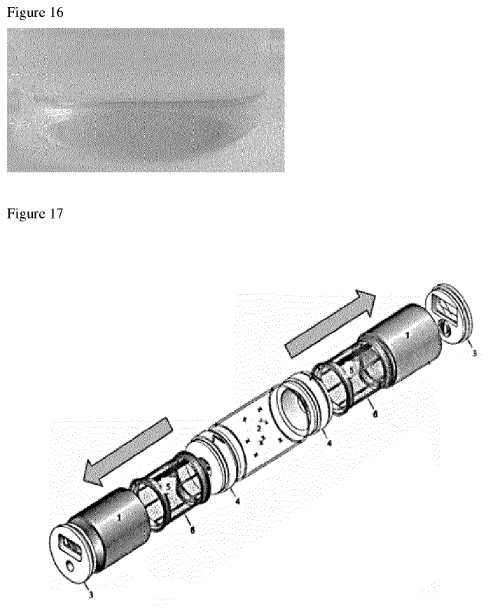

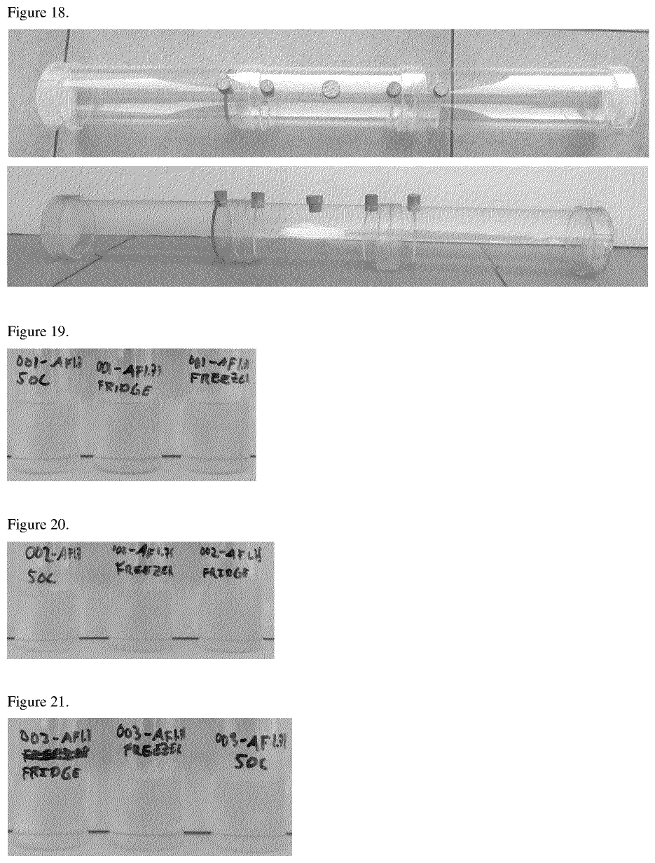

A modular test system was used based on the WHO Guidelines (Guidelines for efficacy testing of spatial repellent, World Health Organization, 2013, ISBN 978 92 4 150 502 4). The spatial repellency assay allowing examination of both spatial repellent and contact irritant responses. The main components of the modular system are illustrated and numbered in FIG. 17. The actual used modular test system is depicted in FIG. 18. The total length of the test system use was 80 cm.

Each treatment cylinder (FIG. 17) was constructed of Plexiglas tubing (9.0 cm outside diameter, 0.3 cm thick, 28.5 cm long, 25 cm long trapping area) and had a butterfly valve installed at one side and an end cap on the other side. The end cap was constructed of a Plexiglas cylinder (9.8 cm outside diameter, 0.4 cm thick, 2.6 cm long), and covered with a membrane that allows air coming in and out of the modular system. The clear middle cylinder (FIG. 18) was constructed of Plexiglas tubing with the same outside diameter and thickness as the treatment cylinders (both ends have an outside diameter 9.8 cm, 0.4 cm thick and length of 3.4 cm) but with a length of 25.8 cm and a trapping area of 16.4 cm. Midway along the length of the clear cylinders, a hole covered with cork provided for transferring mosquitoes.

Treatment filter paper (Whatman No. 1 or similar) was cut to 10×27.5 cm to fit (two pieces) inside the treatment cylinder trapping area and are held in place by scotch tape. The room in which all repellency tests were performed were kept at a temperature of 27±2° C. and a relative humidity of 80±10%.

The spatial repellency assay was performed in a closed temperature and humidity-controlled room, without windows and with light. Groups of 20 female mosquitoes were introduced from holding tubes into the clear cylinder (with an aspirator) and were allowed to acclimatize to the test environment for 30 seconds. The number of mosquitoes that were physically damaged and were incapable of flying or walking were recorded to correct for the total mosquito sample size available to respond to the test sample in that replicate. All butterfly valves were simultaneously opened for 4 min to allow chemical vapours to flow through the test unit and also to allow free movement of the mosquitoes throughout the unit, as indicated by the grey arrows in FIG. 17. The butterfly valves were closed after 4 min, and the number of mosquitoes in each cylinder were recorded. The number of knock-down mosquitoes in each cylinder were also recorded.

The treatment cylinders were disconnected from the centre clear cylinder and the end cap was removed from both treatment cylinders and the mosquitoes were blown out into a mosquito collection cage. Also, the mosquitoes from the centre clear cylinder were blown to the mosquito collection cage. Between the replicates, all treated substrates remained in place. Successive replicates were carried out without delay.

Replicates were performed for each test sample. At the conclusion of testing, the proportion of mosquitoes repelled by the treatment was determined. Spatial repellency was expressed as the proportion of mosquitoes prevented from entering the treatment space in relation to all mosquitoes moving within the system and is calculated from a ‘spatial activity index’:

$$S A I = [ \frac{( Nc - Nt )}{( Nc + Nt )} ] \times ( \frac{Nm}{N} ) ,$$

where SAI is the spatial activity index, Nc is the number of mosquitoes in the control metal chamber, Nt is the number of mosquitoes in the treatment metal chamber, Nm is the total number of mosquitoes in the two metal chambers, and N is the total number of mosquitoes in the test unit.

The spatial activity index varies from −1 to 1: zero indicates no response; −1 indicates that all mosquitoes moved into the treatment chamber, resulting in an attractant response; and 1 indicates that all the mosquitoes moved into the control chamber (away from the treatment source), resulting in a spatial repellent response. If no movement is recorded within the system (i.e. Nₜ=0, Nc=0), the test is valid but the spatial activity index is 0.

The spatial activity index as calculated for each replicate. The number of replicates, the total number of mosquitoes and the spatial activity index for each test sample was reported.

1. A method for dissolving a water-insoluble active compound in water using a composition, comprising:
an alcohol selected from the group consisting of: methanol, ethanol, propanol, propanol derivatives, butanol, and butanol derivatives,
a surfactant, being a quaternary ammonium salt according to Formula I, and
water, 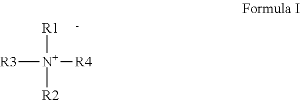
wherein R3 is a C1-18 alkyl or alkene, and
wherein the method comprises:
dissolving the alcohol and surfactant in water to obtain a solution, and
adding the water-insoluble active compound to the solution to obtain a solution of a water-insoluble active compound in water.

2. (canceled)

3. The method of claim 1, wherein the active compound is selected from the group consisting of icaridin, DEET, N,N-Diethyl-meta-toluamide, citronellal, citronellol, eucalyptol, nepetalactone, azadirachtin, A-terpineol, carvacrol, thymol, cinnamaldehyde, Rosemary oil, Cedarwood oil, myrcene, citral, geranyl acetate, nerol, geraniol, limonene, permethrin, zinc-pyrithione, or derivatives thereof, preferably, icaridin or derivatives thereof.

4. The method of claim 1, wherein R4 of Formula I is a methyl group, an alkyl shorter than the alkyls in R1, R2 and R3, or R4 is one to three carbons with a carboxylic acid, hydroxy, sulfonate or phenyl group.

5. The method of claim 1, wherein R1, R2 and R3 are the same.

6. The method of claim 1, wherein R1, R2 are a methyl group, R3 is CₙH₂ₙ₊₁ with n=1-18 and R4 is an alkyl smaller than the alkyls in R1, R2 and R3, or R4 is one to three carbons and a carboxylic acid, hydroxy, sulfonate or phenyl group.

7. The method of claim 1, wherein R1, R2, R3 and R4 are the same.

8. The method of claim 1, wherein the counter ion of the quaternary ammonium salt is a halide anion, preferably a chloride ion or a bromide ion.

9. The method of claim 1, wherein the surfactant is a compound selected from the list consisting of trimethyloctadecylammonium chloride (SQ), stearyltrimethylammonium chloride, hexadecyltrimethylammonium chloride, cetyltrimethylammonium chloride, tetradecyltrimethylammonium bromide, myristyltrimethylammonium bromide, tetradecyltrimethylammonium chloride, dodecyltrimethylammonium bromide, dodecyltrimethylammonium chloride, trimethylactylammonium chloride, tetramethylammonium chloride, dimethyloctadecyl [3-(trimethoxysilyl) propyl] ammonium chloride, cetyl dimethyl betaine, benzalkalkonium chloride, 3-(dimethyl (octadecyl)ammonio)propane-1-sulfonate, N-dodecyl-N,N-(dimethylammonio) butyrate (DDMAB), bezyldimethyldodecylammonium chloride, zephirol, N-dodecyl-N,N-dimethyl-3-ammonio-1-propanesulfonate, domiohen bromide, (lauryldimethylammonio) acetate, didecyldimethylammonium bromide, didodecyldimethylammonium bromide, methyltrioctylammonium chloride, tridodecylmethylammonium chloride, tetraoctylammonium bromide, tetradodecylammonium bromide.

10. The method of claim 1, wherein the surfactant is trimethyloctadecylammonium chloride (SQ).

11. The method of claim 1, wherein the alcohol is propanol, propanol derivatives, butanol, or butanol derivatives.

12. The method of claim 11, wherein the propanol derivative is 2-propanol or isopropyl ether-ethyl alcohol.

13. The method of claim 11, wherein the butanol derivative is selected from the list consisting of tert-butanol, isobutanol, 2-methoxy-3-methyl-1-butanol (MMB), 3-ethoxy-3-methyl-1-butanol, 3-benzyloxy-3-methyl-1-butanol, 3-methyl-3-methyl-1-butanol, 3-methyl-1,3-butanediol, preferably 2-methoxy-3-methyl-1-butanol (MMB).

14. The method of claim 1, wherein the water-insoluble active compound is present in the solution of a water-insoluble active compound in water in about 0.01 wt. % to about 44.9 wt. %, preferably about 0.1 wt. % to about 20 wt. %, more preferably in about 0.1 wt. % to about 10 wt. %, even more preferably in about 0.5 wt. % to about 7 wt. %, even more preferably in about 1 wt. % to about 5 wt. %, most preferably in about 2 wt. % to about 3 wt. % with respect to the total weight of the solution of a water-insoluble active compound in water.

15. The method of claim 1, wherein the surfactant is present in the solution of a water-insoluble active compound in water in about 0.1 wt. % to 6 wt. %, preferably in about 0.5 wt. % to 4 wt. %, more preferably in about 0.75 wt. % to 3 wt. %, most preferably in about 1 wt. % to 2 wt. % with respect to the total weight of the solution of a water-insoluble active compound in water.

16. The method of claim 1, wherein the alcohol is present in the solution of a water-insoluble active compound in water in about 5 wt. % to 49.9 wt. %, preferably in about 7 wt. % to 40 wt. %, more preferably in about 9 wt. % to 30 wt. %, more preferably in about 10 wt. % to 25 wt. %, even more preferably in about 12 wt. % to 16 wt. %, most preferably in about 12.5 wt. % with respect to the total weight of the composition, with the proviso that water is present in the composition in a higher wt. % than any other component of the solution of a water-insoluble active compound in water separately.

17. The method of claim 1, wherein the water is present in the solution of a water-insoluble active compound in water in a higher wt. % than any other component of the solution of a water-insoluble active compound in water separately.

18. The method of claim 1, wherein the water is deionized water.

19. The method of claim 1, wherein the water is present in the solution of a water-insoluble active compound in water in a higher wt. % than the other components of the solution of a water-insoluble active compound in water together.

20. The method of claim 1, wherein water is present in the solution of a water-insoluble active compound in water in more than 50 wt. %, preferably more than 60 wt. %, more preferably in more than 70 wt. %, most preferably in more than 80 wt. % with respect to the total weight of the solution of a water-insoluble active compound in water or wherein the water is present in about 80 wt. % with respect to the total weight of the solution of a water-insoluble active compound in water.

21. The method of claim 1, wherein the solution of a water-insoluble active compound in water comprises 2-methoxy-3-methyl-1-butanol, trimethyloctadecylammonium chloride, icaridin and water.

22. The method of claim 21, wherein the solution of a water-insoluble active compound in water comprises at least 12.5 wt. % methoxy-3-methyl-1-butanol and at least 1 wt. % trimethyloctadecylammonium chloride with respect to the total weight of the solution of a water-insoluble active compound in water.

23. The method of claim 1, wherein alcohol is present in the solution of a water-insoluble active compound in water in at least 12.5 wt. %, preferably between 12.5 wt. % and 50 wt. %, more preferably between 15 wt. % and 40 wt. %, even more preferably between 15 wt. % and 25 wt. %, most preferably in about 20 wt. % with respect to the total weight of the solution of a water-insoluble active compound in water.

24. The method of claim 1, wherein surfactant is present in the in about 0.1 wt. % to 12 wt. %, preferably in about 0.5 wt. % to 8 wt. %, more preferably in about 0.75 wt. % to 4 wt. %, most preferably in about 1 wt. % to 2 wt. % with respect to the total weight of the .

25-29. (canceled)

30. A method for repelling insects, comprising:
applying the solution of a water-insoluble active compound in water as defined in claim 1 on a surface, wherein the surface is preferably human or animal skin, or the surface of a building, part of a building, building material or a coating.

31. (canceled)

32. (canceled)

33. The method of claim 1, further comprising storing the solution of a water-insoluble active compound in water in extreme conditions, wherein the extreme conditions are a temperature between −20° C. and 20° C., in particular between −20° C. and 4° C., more in particular between −20° C. and 0° C., or wherein the extreme conditions are a temperature between 20° C. and 60° C., in particular between 30° C. and 55° C., more in particular between 40° C. and 50° C.

34. (canceled)

35. (canceled)
